(19) United States
(12) Patent Application Publication
(10) Pub. No.: US 2012/0274885 A1
(43) Pub. Date: Nov. 1, 2012

(54) IMAGE DISPLAY APPARATUS INCLUDING PIXEL ELETRODES WITH OPENINGS

(76) Inventors: Kyoungju SHIN, Hwaseong-si (KR); Kyoungtae Kim, Osan-si (KR); Young Gu Kim, Hwaseong-si (KR)

(21) Appl. No.: 13/434,427

(22) Filed: Mar. 29, 2012

(30) Foreign Application Priority Data
Apr. 29, 2011 (KR) 10-2011-0041111

(51) Int. Cl. G02F 1/1335; G02F 1/1337; G02F 1/1343

(52) U.S. Cl. 349/110; 349/142; 349/139; 349/123

(57) ABSTRACT

In an image display apparatus, an array substrate includes a plurality of pixel electrodes, an opposite substrate facing the array substrate, and a liquid crystal layer disposed between the array substrate and the opposite substrate. The liquid crystal layer includes a plurality of vertical alignment liquid crystal molecules and is disposed between the array substrate and the opposite substrate. Each of the pixel electrodes includes a plurality of domains and includes an opening portion formed corresponding to a contact point at which the domains make contact with each other.

### CROSS-REFERENCE TO RELATED APPLICATION

This application relies for priority upon Korean Patent Application No. 10-2011-0041111 filed on Apr. 29, 2011, the contents of which are herein incorporated by reference in its entirety.

BACKGROUND

1. Field of Disclosure

The present invention relates to an image display apparatus. More particularly, the present invention relates to an image display apparatus capable of improving display quality thereof

2. Description of the Related Art

In general, a liquid crystal display applies voltage to a liquid crystal layer to control light transmittance of the liquid crystal layer, thereby displaying an image. Liquid crystal displays are classified into twisted nematic liquid crystal displays, horizontal electric field liquid crystal displays, and vertical alignment liquid crystal displays.

In a vertical alignment liquid crystal display, long axes of liquid crystal molecules are arranged vertically to a substrate of the vertical alignment liquid crystal display while an electric field is not applied. Accordingly, the vertical alignment liquid crystal display has a wide viewing angle and a large contrast ratio.

In order to arrange the liquid crystal molecules in a predetermined direction, a rubbing method or a light alignment method is widely used.

### SUMMARY

One or more embodiments of the present invention are related to an image display apparatus capable of improving an aperture ratio and light transmittance.

The image display apparatus includes an array substrate including a plurality of pixel electrodes, an opposite substrate facing the array substrate, and a liquid crystal layer including a plurality of vertical alignment liquid crystal molecules and disposed between the array substrate and the opposite substrate. Each of the pixel electrodes includes a plurality of domains and includes an opening portion formed corresponding to a contact point at which the domains make contact with each other.

A texture area may be fixed to the contact point, so that movement of the texture area may be prevented even though external impacts are applied to the image display apparatus. In addition, a width of the texture area may be reduced by the opening portion; advantageously, the aperture ratio and the light transmittance of the image display apparatus may be improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating an image display apparatus according to one or more embodiments of the present invention;

FIG. 2 is a cross-sectional view taken along a line I-I′ shown in FIG. 1;

FIGS. 3A and 3B are plan views illustrating texture shapes according to a size of an opening portion;

FIGS. 4A and 4B are plan views illustrating different shapes of the opening portion;

FIG. 5A is a plan view illustrating an alignment direction of a first alignment layer;

FIG. 5B is a plan view illustrating an alignment direction of a second alignment layer;

FIG. 5C is a pan view illustrating a first sub-pixel electrode and a second sub-pixel electrode;

FIG. 6A is a plan view illustrating an alignment direction of a first alignment layer;

FIG. 6B is a plan view illustrating an alignment direction of a second alignment layer;

FIG. 6C is a pan view illustrating a first sub-pixel electrode and a second sub-pixel electrode;

FIG. 7 is a plan view illustrating a pixel of an image display apparatus according to one or more embodiments of the present invention;

FIG. 8 is a cross-sectional view taken along a line II-II′ shown in FIG. 7;

FIG. 9 is a plan view illustrating a pixel of an image display apparatus according to one or more embodiments of the present invention;

FIGS. 10A and 10B are plan views illustrating a conventional pixel electrode and a conventional texture area;

FIGS. 11A and 11B are plan views illustrating a pixel electrode and a texture area according to one or more embodiments of the present invention;

FIG. 12 is a cross-sectional view taken along a line III-III′ shown in FIG. 10B; and

FIG. 13 is a cross-sectional view taken along a line IV-IV′ shown in FIG. 11B.

### DETAILED DESCRIPTION

It will be understood that when an element or layer is referred to as being “on”, “connected to”, or “coupled to” another element or layer, it can be directly on, connected or coupled to the other element or layer or intervening elements or layers may be present. In contrast, when an element is referred to as being “directly on”, “directly connected to”, or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

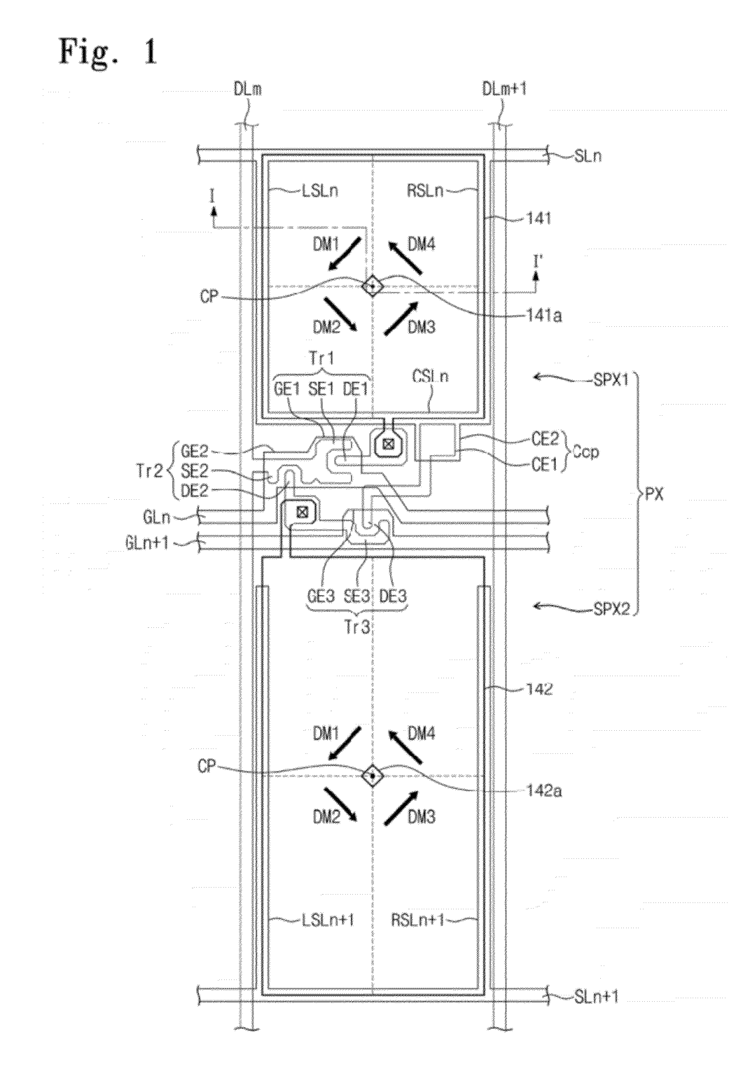

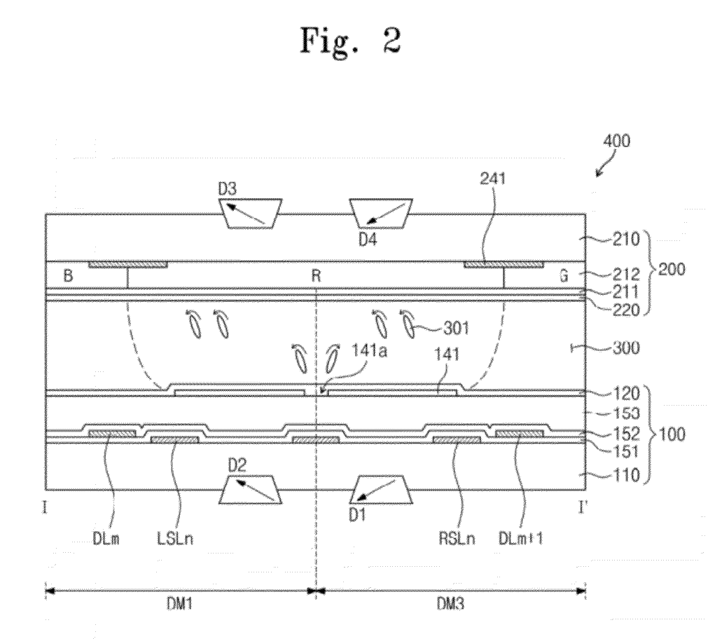

FIG. 1 is a plan view illustrating an image display apparatus 400 according to one or more embodiments of the present invention, and FIG. 2 is a cross-sectional view taken along a line I-I′ shown in FIG. 1.

Referring to FIGS. 1 and 2, the image display apparatus 400 includes an array substrate 100, an opposite substrate 200 facing the array substrate 100 and coupled to the array substrate 100, a liquid crystal layer 300 interposed between the array substrate 100 and the opposite substrate 200.

The array substrate 100 includes a plurality of gate lines, a plurality of data lines, and a plurality of pixels arranged in a matrix form. In FIGS. 1 and 2, one pixel PX, gate lines GLn and GLn+1, and data lines DLm and DLm+1, which are related to the one pixel PX, have been illustrated.

In detail, the array substrate 100 includes a first base substrate 110 formed of a transparent insulating substrate. A gate wire part, which includes first and second gate lines GLn and GLn+1, first and second storage lines SLn and SLn+1, first, second, third, and fourth branch electrodes LSLn, RSLn, LSLn+1, and RSLn+1, and a connection electrode CSLn connecting the first and second branch electrodes LSLn and RSLn, is disposed on the first base substrate 110.

The array substrate 100 further includes a gate insulating layer 151 to cover the gate wire part, and a data wire part including first and second data lines DLm and DLm+1 is disposed on the gate insulating layer 151 and the gate wire part. The data wire part is covered by a protection layer 152, and an organic insulating layer 153 is disposed on the protection layer 152.

The pixel electrode is disposed on the organic insulating layer 153. As an example, the pixel electrode includes a first sub-pixel electrode 141 and a second sub-pixel electrode 142.

The array substrate 100 further includes a first alignment layer 120 to cover the first and second sub-pixel electrodes 141 and 142. The first alignment layer 120 may include a polymer material in which a decomposition, dimerization, and/or isomerization reaction occurs in response to light (e.g., an ultraviolet ray or a laser). In addition, the first alignment layer 120 may include oligomer cinnamate mixed with polymer-based cinnamate. In addition, the first alignment layer 120 may include a reactive mesogen.

The opposite substrate 200 includes a second base substrate 210 facing the first base substrate 110. A color filter layer 212 including red, green, and blue color pixels R, G, and B is disposed on the second base substrate 210. A common electrode 211 is disposed on the color filter layer 212. The common electrode 211 faces the first and second sub-pixels 141 and 142.

The opposite substrate 200 further includes a second alignment layer 220 to cover the common electrode 211. The second alignment layer 220 may include a polymer material in which a decomposition, dimerization, or isomerization reaction occurs in response to light (e.g., an ultraviolet ray or a laser). In addition, the second alignment layer 220 may include oligomer cinnamate mixed with polymer-based cinnamate. In addition, the second alignment layer 220 may include a reactive mesogen.

As shown in FIG. 1, each pixel PX disposed on the array substrate 100 includes a first sub-pixel SPX1 and a second sub-pixel SPX2. The first sub-pixel SPX1 includes a first thin film transistor Tr1 and the first sub-pixel electrode 141. The second sub-pixel SPX2 includes a second thin film transistor Tr2, the second sub-pixel 142, a third thin film transistor Tr3, and a coupling capacitor Ccp. The first and second sub-pixels SPX1 and SPX2 are disposed between the first and second data lines DLm and DLm+1 adjacent to each other.

The first thin film transistor Tr1 is connected to the first data line DLm and the first gate line GLn. In detail, the first thin film transistor Tr1 includes a first source electrode SE1 connected to the first data line DLm, a first gate electrode GE1 connected to the first gate line GLn, and a first drain electrode DE1 connected to the first sub-pixel electrode 141. The first sub-pixel electrode 141 overlaps the first storage line SLn, the first and second branch electrodes LSLn and RSLn, and the first connection electrode CSLn.

The second thin film transistor Tr2 also is connected to the first data line DLm and the first gate line GLn. The second thin film transistor Tr2 includes a second source electrode SE2 connected to the first data line DLm, a second gate electrode GE2 connected to the first gate line GLn, and a second drain electrode DE2 connected to the second sub-pixel electrode 142. The second sub-pixel electrode 142 overlaps the second storage line SLn+1 and the third and fourth branch electrode LSLn+1 and RSLn+1.

When a first gate signal is applied to the first gate line GLn, the first and second thin film transistors Tr1 and Tr2 are substantially simultaneously turned on. The data voltage applied to the first data line DLm is applied to the first and second sub-pixel electrodes 141 and 142 through the first and second thin film transistors Tr1 and Tr2. Accordingly, the pixel voltage (or electric potential) of the first and second sub-pixel electrodes 141 and 142 is maintained in the same level during the application of the first gate signal.

The third thin film transistor Tr3 includes a third source electrode SE3 connected to the second drain electrode DE2 of the second thin film transistor Tr2, a third gate electrode GE3 connected to the second gate line GLn+1, and a third drain electrode DE3 connected to the coupling capacitor Ccp. In one or more embodiments, the coupling capacitor Ccp may include a first electrode CE1 extended from the third drain electrode DE3 and a second electrode CE2 extended from the connection electrode CSLn to face the first electrode CE1 with an insulating layer (not shown) being interposed therebetween. However, the structure of the coupling capacitor Ccp should not be limited thereto or thereby.

The second gate line GLn+1 receives a second gate signal that rises after the first gate signal falls. The third thin film transistor Tr3 is turned on in response to the second gate signal, and the pixel voltage applied to the second sub-pixel electrode 142 is lowered by the coupling capacitor Ccp. The lowered level of the pixel voltage may be varied depending on the charge in the capacitor Ccp.

Consequently, after the second gate signal is generated, the pixel voltage of the first sub-pixel electrode 141 has a voltage level different from that of the second sub-pixel electrode 142.

Each of the first and second sub-pixel electrodes 141 and 142 may include first, second, third, and fourth domains DM1, DM2, DM3, and DM4 having different liquid crystal alignment directions. As an example, the liquid crystal alignment directions of from first domain D1 to the fourth domain DM4 may be rotated in a counter-clockwise manner or a clockwise manner.

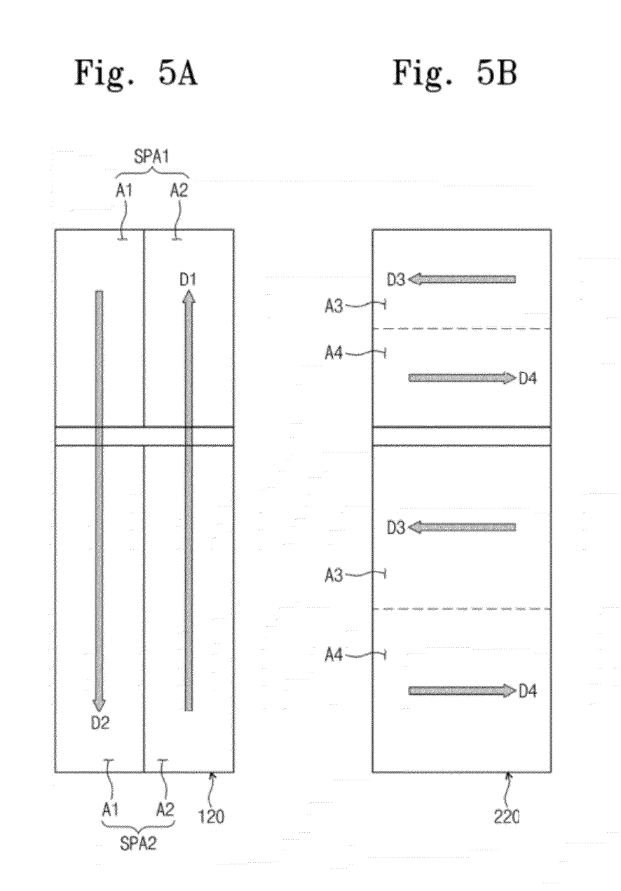

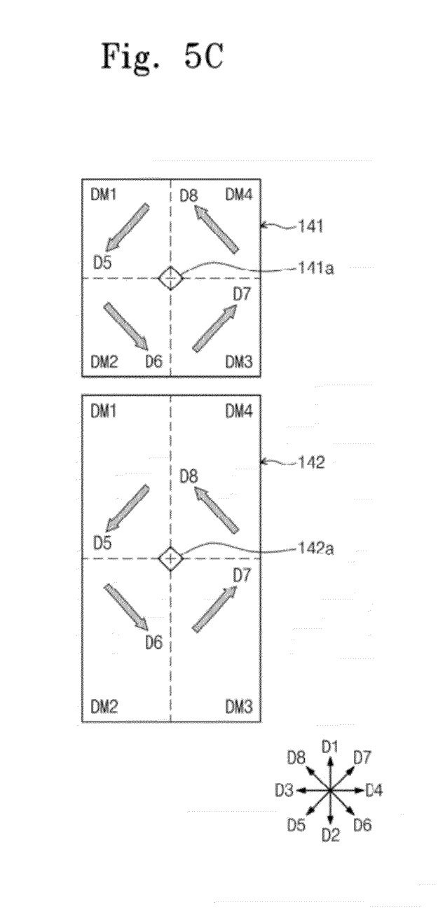

The liquid crystal alignment directions of the first to fourth domains DM1 to DM4 will be described in detail with reference to FIGS. 5A to 5C.

As shown in FIG. 1, the first sub-pixel electrode 141 includes a first opening portion 141a that is formed in an area corresponding to a contact point CP where the first to fourth domains DM1 to DM4 make contact with each other. The first opening portion 141a may have a lozenge shape having a center portion thereof corresponding to the contact point CP.

Four sides that define the first opening portion 141a are positioned in the first to fourth domains DM1 to DM4, respectively, and each of the four sides is substantially parallel to the liquid crystal alignment direction of a corresponding domain of the first to fourth domains DM1 to DM4.

The second sub-pixel electrode 142 includes a second opening portion 142a that is formed in an area corresponding to a contact point CP where the first to fourth domains DM1 to DM4 make contact with each other. The second opening portion 142a may have a lozenge shape having a center portion thereof corresponding to the contact point CP.

Four sides that define the second opening portion 142a are positioned in the first to fourth domains DM1 to DM4, respectively, and each of the four sides is substantially parallel to the liquid crystal alignment direction of a corresponding domain of the first to fourth domains DM1 to DM4.

As shown in FIG. 2, the first alignment layer 120 includes a first area in which the first alignment layer 120 is light-aligned in a first direction D1 and a second area in which the first alignment layer 120 is light-aligned in a second direction D2 different from the first direction D1. In the light-align process of the first alignment layer 120, the light is inclinedly irradiated onto the first area of the first alignment layer 120 to perform the first exposure process on the first area of the first alignment layer 120. Then, the light is inclinedly irradiated onto the second area of the first alignment layer 120 to perform the second exposure process on the second area of the first alignment layer 120. When the exposure processes are completely finished, the pretilt angle is formed to be inclined toward the first direction D1 in the first area of the first alignment layer 120, and the pretilt angle is formed to be inclined toward the second direction D2 in the second area of the first alignment layer 120. Accordingly, the liquid crystal molecules of the liquid crystal layer 300 may be vertically aligned by the first alignment layer 120 while being inclined by the pretilt angle when no electric field is applied.

The second alignment layer 220 includes a third area in which the second alignment layer 220 is light-aligned in a third direction D3 different from the first and second directions D1 and D2 and a fourth area in which the second alignment layer 220 is light-aligned in a fourth direction D4 different from the third direction D3. In the light-align process of the second alignment layer 220, the light is inclinedly irradiated onto the third area of the second alignment layer 220 to perform the third exposure process on the third area of the second alignment layer 220. Then, the light is inclinedly irradiated onto the fourth area of the second alignment layer 220 to perform the second exposure process on the fourth area of the second alignment layer 220. When the exposure processes are completely finished, the pretilt angle is formed to be inclined toward the third direction D2 in the third area of the second alignment layer 220, and the pretilt angle is formed to be inclined toward the fourth direction D4 in the fourth area of the second alignment layer 220. Accordingly, the liquid crystal molecules of the liquid crystal layer 300 may be vertically aligned by the second alignment layer 220 while being inclined by the pretilt angle when no electric field is applied.

In one or more embodiments, the first domain DM1 is defined by the second and third areas (which overlap each other), and the third domain DM3 is defined by the first and fourth areas (which overlap each other).

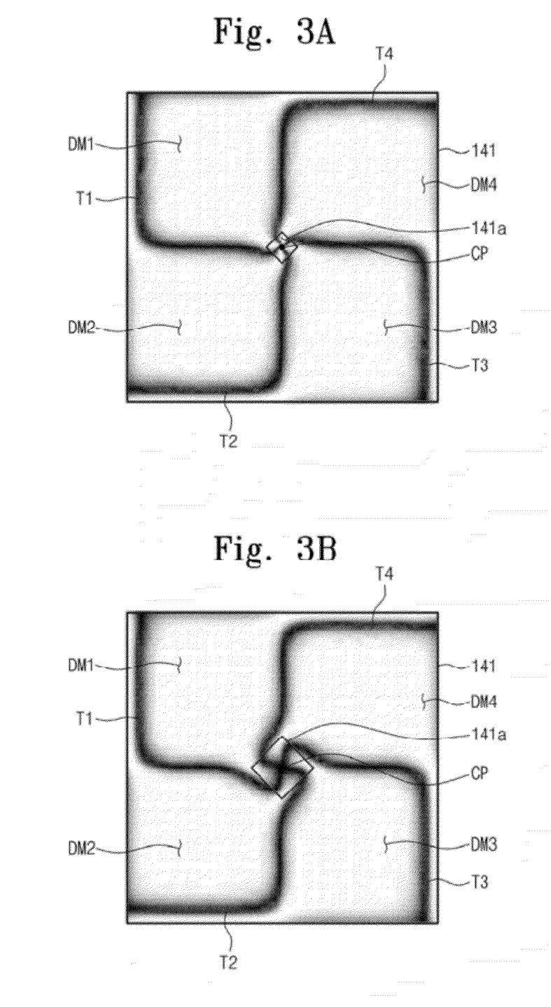

FIGS. 3A and 3B are plan views illustrating texture shapes according to a size of an opening portion. FIG. 3A shows the texture shape on the first sub-pixel electrode 141 through which the first opening portion 141a having a first size is formed, and FIG. 3B shows the texture shape on the first sub-pixel electrode 141 through which the first opening portion 141a having a second size is formed.

Referring to FIGS. 3A and 3B, the liquid crystal alignment directions of the first to fourth domains DM1 to DM4 in the first sub-pixel electrode 141 are rotated in a counter-clockwise manner from the first domain DM1 to the fourth domain DM4. In one or more embodiments, a fringe field is formed at boundaries between the first to fourth domains DM1 to DM4. Thus, a first texture area T1 and a second texture area T2 are formed in the first sub-pixel electrode 141. The first texture area T1 is formed along an end of the first domain DM1 and has an L-shape, and the second texture area T2 is formed along an end of the second domain DM2 and has an L-shape rotated counter-clockwise by about 90 degrees relative to the first texture area T1. In addition, a third texture area T3 and a fourth texture area T4 are formed in the first sub-pixel electrode 141. The third texture area T3 is formed along an end of the third domain DM3 and has an L-shape rotated counter-clockwise direction by about 180 degrees relative to the first texture area T1, and the fourth texture area T4 is formed along an end of the fourth domain DM4 and has an L-shape rotated clockwise by about 90 degrees relative to the first texture area T1. The first to fourth texture areas T1 to T4 may be defined by areas in which liquid crystal molecules are misaligned by liquid crystal directors that collide with each other.

When the first opening portion 141a is provided to (or formed through) the first sub-pixel electrode 141, a position at which the first to fourth texture areas T1 to T4 do not shift by external shocks. In detail, when the first sub-opening portion 141a is formed through the first sub-pixel electrode 141, the fringe field is formed at each of the four sides defining the first opening portion 141a and direction of the fringe field is formed toward the contact point CP (where the first to fourth domains DM1 to DM4 contact each other). Therefore, a position at which the first to fourth texture areas T1 to T4 make contact with each other may be fixed to the position of the contact point CP by the fringe field.

Accordingly, the first to fourth texture areas T1 to T4 are strongly formed around the contact point CP by a vector sum of a component of the fringe field applied to an inside portion of the first sub-pixel electrode 141 from an outside portion of the first sub-pixel electrode 141 and a component of a fringe field applied to the outside portion of the first sub-pixel electrode 141 from the contact point CP of the first sub-pixel electrode 141.

As a result, the first to fourth texture areas T1 to T4 are secured in areas adjacent to the contact point CP, so that the position and shape of the first to fourth texture areas T1 to T4 may be prevented from being deformed by external impacts.

The first opening portion 141a illustrated in FIG. 3A has a first size of about 10 micrometers by about 10 micrometers; the first opening portion 141a illustrated in FIG. 3B has a second size of about 20 micrometers by about 20 micrometers. If the size of the first opening portion 141a is increased, intensity of the fringe field formed at each of the four sides defining the first opening portion 141a is increased. Therefore, the first to fourth texture areas T1 to T4 may be easily fixed to the contact point CP. Thus, the position of the first to fourth texture areas T1 to T4 may be prevented from being changed by the external impacts.

However, if the size of the first opening portion 141a is increased, an aperture ratio and light transmittance of each pixel may be lowered. Accordingly, the size of the first opening portion 141a should be determined in consideration of the aperture ratio and the light transmittance (unless the position of the first to fourth texture areas T1 to T4 is changed).

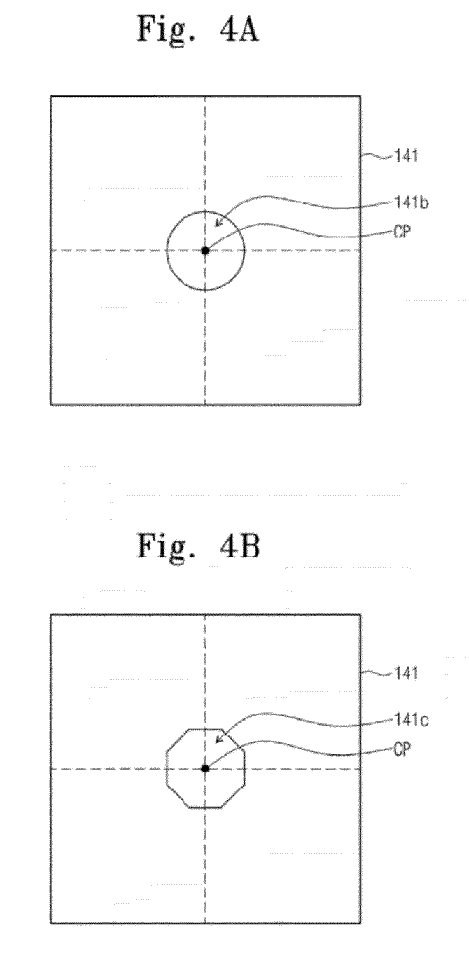

FIGS. 4A and 4B are plan views illustrating different shapes of the first opening portion formed on the first sub-pixel electrode 141.

Referring to FIG. 4A, the first opening portion 141b may have a circular shape having a center thereof at the contact point CP.

In addition, referring to FIG. 4B, the first sub-pixel electrode 141 may include a first opening portion 141c having a hexagonal shape. Six sides that define the hexagonal shape of the first opening portion 141c are spaced apart from the contact point CP by the same distance.

The first opening portion may have various shapes in various embodiments.

FIG. 5A is a plan view illustrating an alignment direction of the first alignment layer 120. FIG. 5B is a plan view illustrating an alignment direction of the second alignment layer 220. FIG. 5C is a plan view illustrating the first sub-pixel electrode 141 and the second sub-pixel electrode 142.

Referring to FIGS. 5A and 5B, the first alignment layer 120 is divided into a first area A1 and a second area A2 in each of a first sub-pixel area SPA1 and a second sub-pixel area SPA2. The first alignment layer 120 is light-aligned in the second direction D2 in the first area A1, and the first alignment layer 120 is light-aligned in the first direction D1 in the second area A2, wherein the second direction D2 is opposite to the first direction D1.

The second alignment layer 220 include a third area A3 and a fourth area A4 in each of two areas corresponding to the first sub-pixel area SPA1 and the second sub-pixel area SPA2. The second alignment layer 220 is light-aligned in the third direction D3 in the third area A3, and the second alignment layer 220 is light-aligned in the fourth direction D4 in the fourth area A4, wherein the fourth direction D4 is opposite to the third direction D3.

FIG. 5C illustrates that the first to fourth domains DM1 to DM4 are formed in each of the first and second sub-pixel electrodes 141 and 142. Given that the array substrate 100 is coupled with the opposite substrate 200, the first domain DM1 is defined by an area in which the first and third areas A1 and A3 overlap each other, the second domain DM2 is defined by an area in which the first and fourth areas A1 and A4 overlap each other, the third domain DM3 is defined by an area in which the second and fourth areas A2 and A4 overlap each other, and the fourth domain DM4 is defined by an area in which the second and third areas A2 and A3 overlap each other.

The liquid crystal molecules in the first to fourth domains DM1 to DM4 may be arranged in different directions. In detail, the liquid crystal molecules in the first domain DM1 are arranged in a fifth direction D5 defined by the vector sum of the second and third directions D2 and D3, the liquid crystal molecules in the second domain DM2 are arranged in a sixth direction D6 defined by the vector sum of the second and fourth directions D2 and D4, the liquid crystal molecules in the third domain DM3 are arranged in a seventh direction D7 defined by the vector sum of the first and fourth directions D1 and D4, and the liquid crystal molecules in the fourth domain DM4 are arranged in a eighth direction D8 defined by the vector sum of the first and third directions D1 and D3.

Thus, as shown in FIG. 5C, the alignment directions of the liquid crystal may be rotated in a counter-clockwise manner from the first domain DM1 to the fourth domain DM4. Given that the first to fourth domains DM1 to DM4 having different liquid crystal alignment directions are formed in each of the first and second sub-pixel areas SPA1 and SPA2, the viewing angle of the liquid crystal display may be improved.

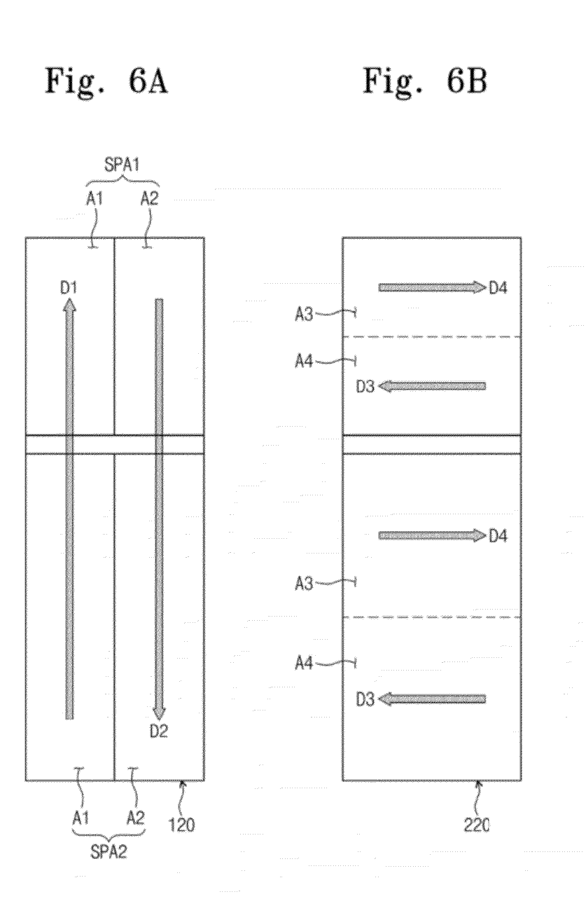

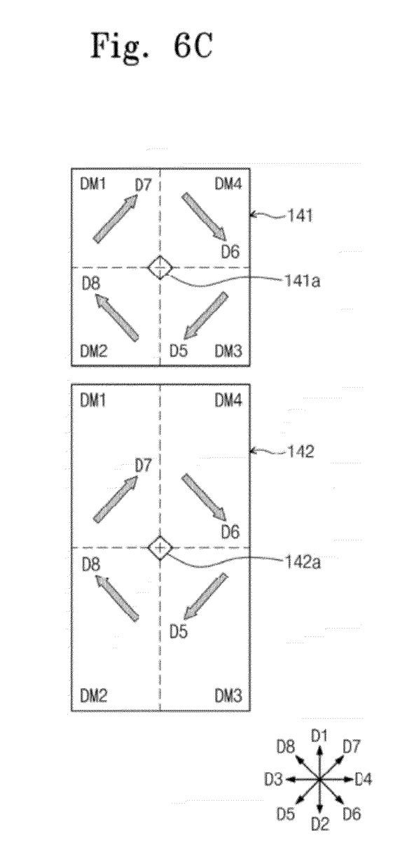

FIG. 6A is a plan view illustrating an alignment direction of the first alignment layer 120 according to another embodiments of the present invention. FIG. 6B is a plan view illustrating an alignment direction of the second alignment layer 220 according to another embodiments of the present invention. FIG. 6C is a plan view illustrating the first sub-pixel electrode 141 and the second sub-pixel electrode 142.

Referring to FIGS. 6A and 6B, the first alignment layer 120 is divided into a first area A1 and a second area A2 in each of a first sub-pixel area SPA1 and a second sub-pixel area SPA2. The first alignment layer 120 is light-aligned in the first direction D1 in the first area A1, and the first alignment layer 120 is light-aligned in the second direction D2 in the second area A2, wherein the second direction D2 is opposite to the first direction D1.

The second alignment layer 220 include a third area A3 and a fourth area A4 in each of two areas corresponding to the first sub-pixel area SPA1 and the second sub-pixel area SPA2. The second alignment layer 220 is light-aligned in the fourth direction D4 in the third area A3, and the second alignment layer 220 is light-aligned in the third direction D3 in the fourth area A4, wherein the fourth direction D4 is opposite to the third direction D3.

FIG. 6C illustrates that the first to fourth domains DM1 to DM4 are formed in each of the first and second sub-pixel electrodes 141 and 142. Given that the array substrate 100 is coupled with the opposite substrate 200, the first domain DM1 is defined by an area in which the first and third areas A1 and A3 overlap each other, the second domain DM2 is defined by an area in which the first and fourth areas A1 and A4 overlap each other, the third domain DM3 is defined by an area in which the second and fourth areas A2 and A4 overlap each other, and the fourth domain DM4 is defined by an area in which the second and third areas A2 and A3 overlap each other.

The liquid crystal molecules in the first to fourth domains DM1 to DM4 may be arranged in different directions. In detail, the liquid crystal molecules in the first domain DM1 are arranged in the seventh direction D7 defined by the vector sum of the first and fourth directions D1 and D4, the liquid crystal molecules in the second domain DM2 are arranged in the eighth direction D8 defined by the vector sum of the first and third directions D1 and D3, the liquid crystal molecules in the third domain DM3 are arranged in the fifth direction D5 defined by the vector sum of the second and third directions D2 and D3, and the liquid crystal molecules in the fourth domain DM4 are arranged in a sixth direction D6 defined by the vector sum of the second and fourth directions D2 and D4.

Thus, as shown in FIG. 6C, the alignment directions of the liquid crystal may be rotated in a clockwise manner from the first domain DM1 to the fourth domain DM4. Given that the first to fourth domains DM1 to DM4 having different liquid crystal alignment directions are formed in each of the first and second sub-pixel areas SPA1 and SPA2, the viewing angle of the liquid crystal display may be improved.

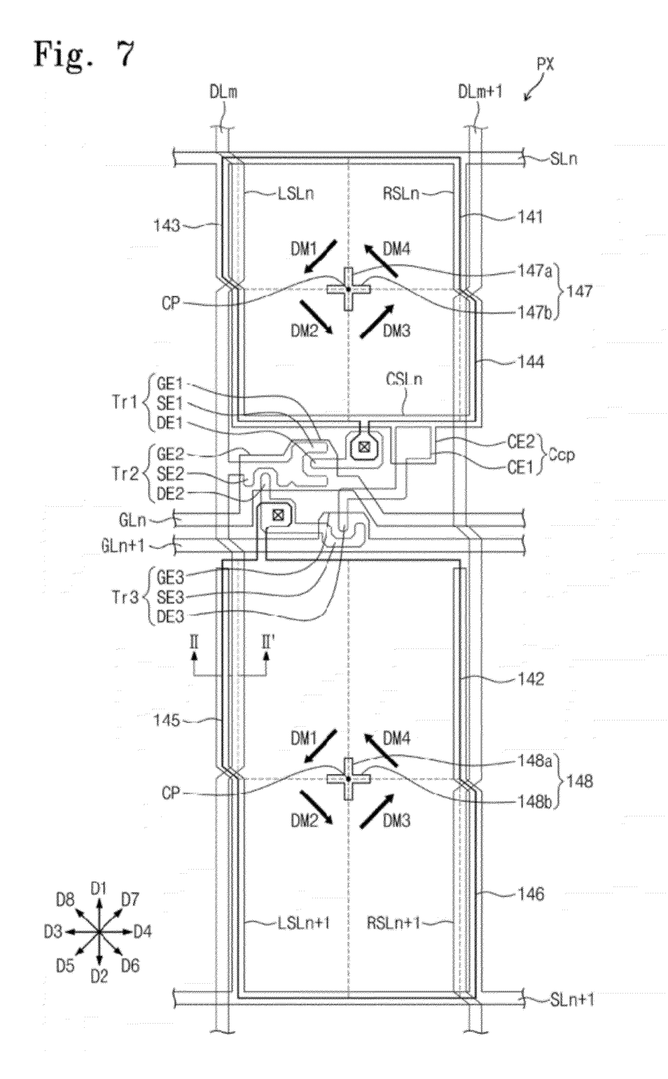

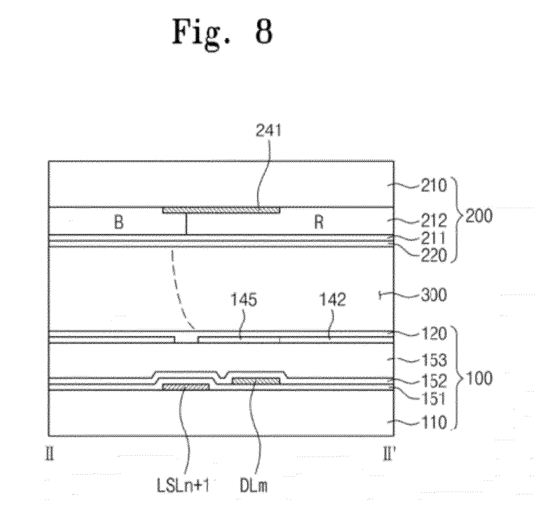

FIG. 7 is a plan view illustrating a pixel of an image display apparatus according to one or more embodiments of the present invention, and FIG. 8 is a cross-sectional view taken along a line II-I′ shown in FIG. 7. In FIG. 7, the same reference numerals denote the same elements in FIG. 1, and thus detailed descriptions of the same elements may be omitted.

Referring to FIG. 7, each of the first and second sub-pixel electrodes 141 and 142 is divided into first to fourth domains DM1 to DM4, and the liquid crystal alignment directions of the first to fourth domains DM1 to DM4 are rotated in a counter-clockwise manner from the first domain DM1 to the fourth domain DM4. In detail, the liquid crystal alignment direction in the first domain DM1 is the fifth direction D5 defined by the vector sum of the second and third directions D2 and D3, the liquid crystal alignment direction in the second domain DM2 is the sixth direction D6 defined by the vector sum of the second and fourth directions D2 and D4, the liquid crystal alignment direction in the first domain DM3 is the seventh direction D7 defined by the vector sum of the first and fourth directions D1 and D4, and the liquid crystal alignment direction in the fourth domain DM4 is the eighth direction D8 defined by the vector sum of the first and third directions D1 and D3.

The first and second sub-pixel electrodes 141 and 142 respectively include a third opening portion 147 and a fourth opening portion 148 each of which is formed corresponding to the contact point CP. The third opening portion 147 includes a first opening 147a and a second opening 147b crossing the first opening 147a at the contact point CP of the first sub-pixel electrode 141 to form a cross shape, and the fourth opening portion 148 includes a first opening 148a and a second opening 148b crossing the first opening 148a at the contact point CP of the second sub-pixel electrode 142 to form a cross shape.

In detail, each of the first openings 147a and 148a is positioned between the first and fourth domains DM1 and DM4 and between the second and third domains DM2 and DM3, and each of the second openings 147b and 148b is positioned between the first and second domains DM1 and DM2 and between the third and fourth domains DM3 and DM4.

In one or more embodiments, the first sub-pixel electrode 141 further includes a first extension portion 143 extending in the third direction D3 in the first domain DM1 and a second extension portion 144 extending in the fourth direction D4 in the third domain DM3. In addition, the second sub-pixel electrode 142 further include a third extension portion 145 extending in the third direction D3 in the first domain DM1 and a fourth extension portion 146 extending in the fourth direction D4 in the third domain DM3.

The first data line DLm may include a first portion disposed inside an edge of the first extension portion 143 in the area corresponding to the first extension portion 143 and overlapping the first domain DM1 of the first sub-pixel electrode 141. The first data line DLm may further include a second portion disposed outside a first edge of the first sub-pixel electrode 141 and not overlapping the second domain DM2 of the first sub-pixel electrode 141. The first data line DLm may further include a third portion disposed inside an edge of the third extension portion 145 in the area corresponding to the third extension portion 145 and overlapping the first domain DM1 of the second sub-pixel electrode 142. The first data line DLm may further include a fourth portion disposed outside a first edge of second sub-pixel electrode 142 and not overlapping the second domain DM2 of the second sub-pixel electrode 142. As illustrated in FIG. 7, the first data line DLm may be bent four times in every one pixel.

The second data line DLm+1 may include a first portion disposed outside a second edge of the first sub-pixel electrode 141 and not overlapping the fourth domain DM4 of the first sub-pixel electrode 141. The second data line DLm+1 may further include a second portion disposed inside an edge of the second extension portion 144 in the area corresponding to the second extension portion 144 and overlapping the third domain DM3 of the first sub-pixel electrode 141. The second data line DLm+1 may further include a third portion disposed outside a second edge of the second sub-pixel electrode 142 and not overlapping the four domain DM4 of the second sub-pixel electrode 142. The second data line DLm+1 may further include a fourth portion disposed inside an edge of the fourth extension portion 146 in the area corresponding to the fourth extension portion 146 and overlapping the third domain DM3 of the second sub-pixel 142. As illustrated in FIG. 7, the second data line DLm+1 may be bent four times in every one pixel.

The fringe field is formed at an edge portion of each of the first and second sub-pixel electrodes 141 and 142 according to the liquid crystal alignment direction of each domain. Particularly, the fringe field is formed at the left side of the first domain DM1 and the right side of the fourth domain DM4. When the fringe field is formed, the liquid crystal molecules may be misaligned in the area in which the fringe field is formed.

The first to fourth extension portions 143, 144, 145, and 146 are formed corresponding to the fringe field, and thus the edge portion of the first and second sub-pixel electrodes 141 and 142 may move to the area in which a black matrix is formed, thereby preventing texture defects (which is caused by the misalignment of the liquid crystal molecules) from occurring.

Referring to FIG. 8, the third extension portion 145 of the second sub-pixel electrode 142 is positioned at the area corresponding to the area in which the black matrix 241 on the opposite substrate 200 is formed, such that the third extension portion 145 overlaps the black matrix 241. In addition, the first data line DLm is positioned at an inner side than the first branch electrode LSLn and overlaps the third extension portion 145. Accordingly, the black matrix may cover the texture defects area (potentially caused by the misalignment of the liquid crystal molecules), and thus the texture defects may be prevented from being displayed.

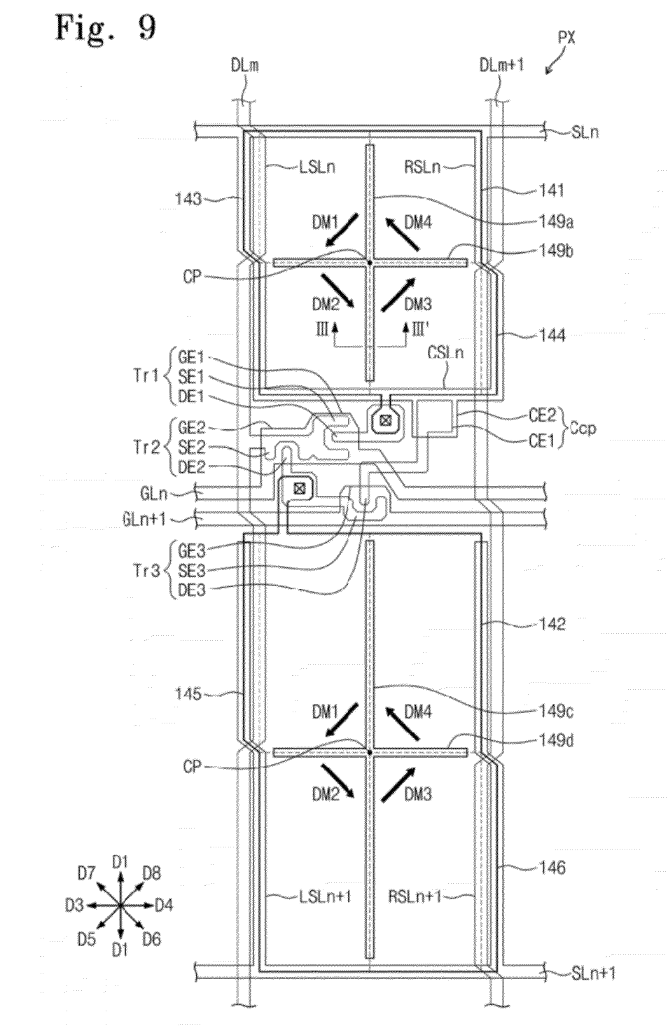

FIG. 9 is a plan view illustrating a pixel of an image display apparatus according to one or more embodiments of the present invention. In FIG. 9, the same reference numerals denote the same elements in FIG. 7, and thus detailed descriptions of the same elements may be omitted.

Referring to FIG. 9, the first sub-pixel electrode 141 includes openings 149a and 149c and the second sub-pixel electrode 142 includes openings 149b and 149d. The openings 149a and 149c and the openings 149b and 149d have the same structure and function as those of the first openings 147a and 148a and the second openings 147b and 148b (illustrated in the example of FIG. 7) except that the openings 149a and 149c are larger than first openings 147a and 148a, and that the openings 149b and 149d are larger than the second openings 147b and 148b.

In detail, the openings 149a and 149c are elongated in the first and second directions D1 and D2 when compared with the third openings 149a and 149c, and the openings 149b and 149d are elongated in the third and fourth directions D3 and D4 when compared with the second openings 147b and 148b.

Accordingly, the openings 149a and 149c may be formed substantially corresponding to the entire boundary between the first and fourth domains DM1 and DM4 and between the second and third domains DM2 and DM3. In addition, the openings 149b and 149d may be formed substantially corresponding to the entire boundary between the first and second domains DM1 and DM2 and between the third and fourth domains DM3 and DM4.

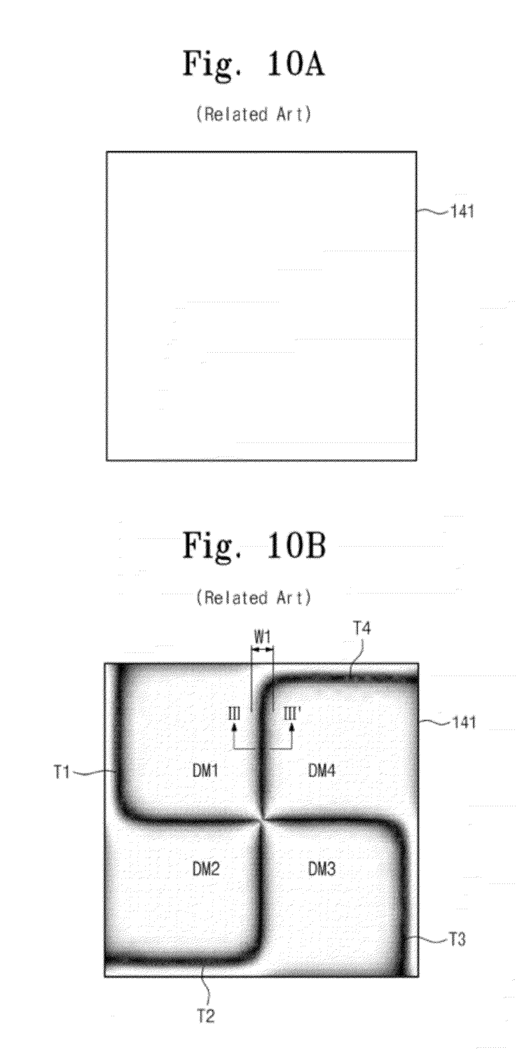

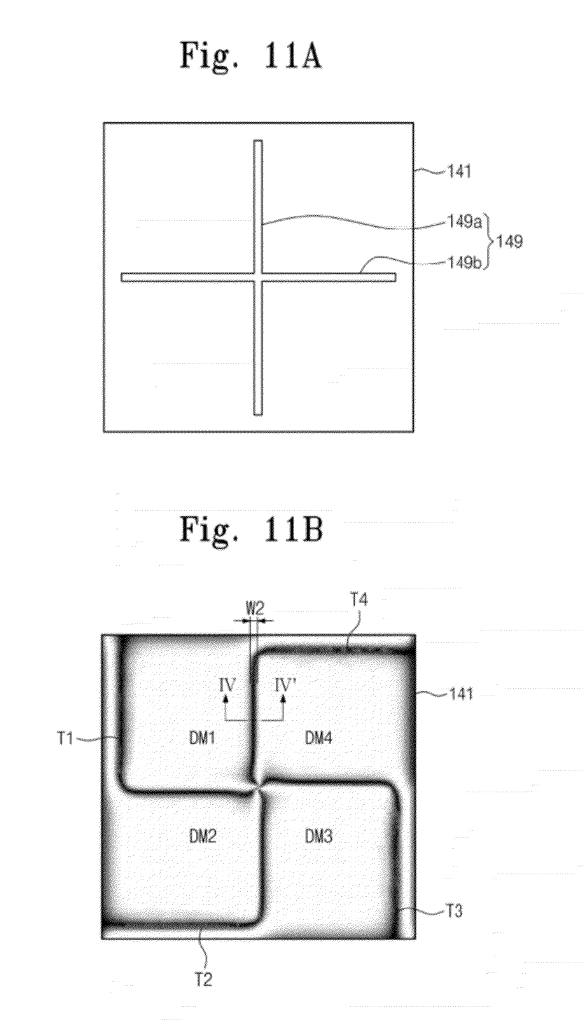

FIGS. 10A and 10B are plan views illustrating a conventional pixel electrode and a conventional texture area, and FIGS. 11A and 11B are plan views illustrating a pixel electrode and a texture area according to one or more embodiments of the present invention.

Referring to FIGS. 10A and 10B, a conventional first sub-pixel electrode 141 does not include the first opening portion 147 or the second opening portion 148 shown in FIG. 7; the conventional first sub-pixel electrode 141 also does not include the openings 149a-149d shown in FIG. 9. In this case, each of the first to fourth texture areas T1 to T4 has a first width W1, which is formed corresponding to the boundary between each pair of the first to fourth domains DM1 to DM4 of the first sub-pixel electrode 141.

As shown in FIGS. 11A and 11B, when the first sub-pixel electrode 141 includes an opening portion 149, which includes the openings 149a and 149b as shown in FIG. 9. Each of the first to fourth texture areas T1 to T4 has a second width W2 smaller than the first width W1 illustrated in the example of FIGS. 10A and 10B.

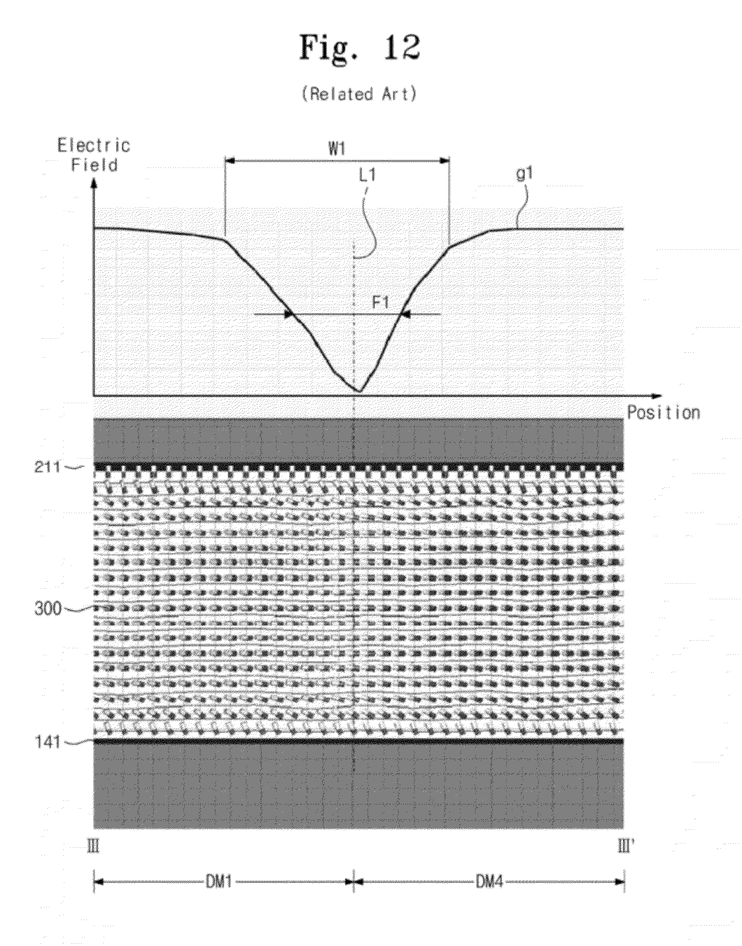

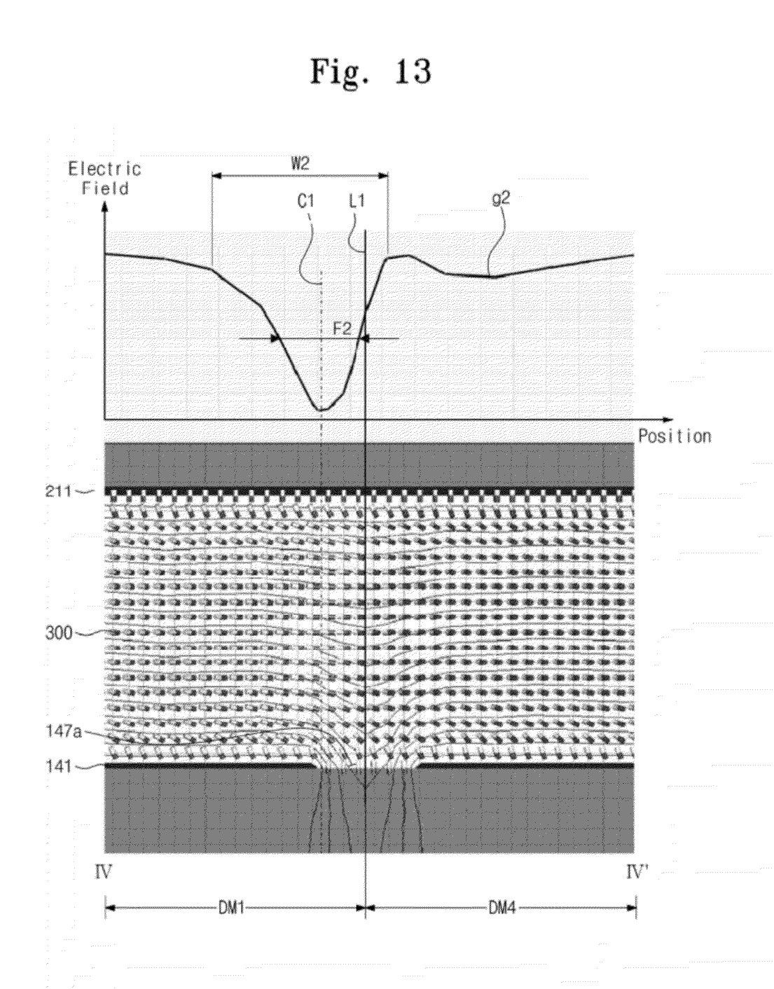

FIG. 12 is a cross-sectional view taken along a line III-III′ shown in FIG. 10B, and FIG. 13 is a cross-sectional view taken along a line IV-IV′ shown in FIG. 11B.

Referring to FIG. 12, a boundary line that divides the first and second domains DM1 and DM4 is referred to as ‘L1’. As represented by a first graph g1, the fourth texture area T4 has a lowest electric field near the position of the boundary line L1. Accordingly, a center line of the fourth texture area T4 substantially corresponds to the boundary line L1. In addition, the fourth texture area T4 has a first full-width half maximum (FWHM) F1.

In contrast, referring to the graph g2 in FIG. 13, if the first sub-pixel electrode 141 includes the third opening portion 149, the fourth texture area T4 has the lowest electric field at the position substantially shifted from the boundary line L1 to the left side of the boundary line L1.

Thus, according to one or more embodiments of the invention, a center line C1 of the fourth texture area T4 is positioned at the left side of the boundary line L1. In addition, according to one or more embodiments, the fourth texture area T4 has a second full-width half maximum F2 smaller than the first full-width half maximum F1 (illustrated in FIG. 12). For instance, when the first full-width half maximum F1 is about 5.3 micrometers, the second full-width half maximum F2 may be about 3.8 micrometers.

In one or more embodiments of the invention, the first and second sub-pixel electrodes 141 and 142 include the third opening portion 149. Accordingly, the width of the first to fourth texture areas T1 to T4 may be reduced. Advantageously, the aperture ratio and the light transmittance of each pixel may be improved.

Although embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An image display apparatus comprising:
an array substrate comprising a plurality of pixel electrodes;
an opposite substrate facing the array substrate; and
a liquid crystal layer comprising a plurality of vertical alignment liquid crystal molecules and disposed between the array substrate and the opposite substrate,
wherein each of the pixel electrodes includes a plurality of domains and comprises an opening portion formed corresponding to a contact point at which the domains make contact with each other.

2. The image display apparatus of claim 1, wherein the opening portion has a lozenge, circular, octagonal, or hexagonal shape, the contact point being at a center portion of the opening portion.

3. The image display apparatus of claim 1, wherein each of the pixel electrode includes first, second, third, and fourth domains, and liquid crystal alignment directions of the first to fourth domains are rotated in a counter-clockwise manner or a clockwise manner from the first domain to the fourth domain.

4. The image display apparatus of claim 3, wherein the opening portion has a lozenge shape, four sides that define the opening portion are positioned in the first to fourth domains, respectively, and each of the four sides is substantially parallel to a liquid crystal alignment direction of a corresponding domain of the first to fourth domains.

5. The image display apparatus of claim 1, wherein the opening portion comprises a first opening and a second opening crossing the first opening at the contact point to form a cross shape.

6. The image display apparatus of claim 5, wherein each of the pixel electrodes includes first, second, third, and fourth domains, the first opening is provided between the first domain and the fourth domain and between the second domain and the third domain, and the second opening is provided between the first domain and the second domain and between the third domain and the fourth domain.

7. The image display apparatus of claim 6, wherein liquid crystal alignment directions of the first to fourth domains are rotated in a counter-clockwise manner or a clockwise manner from the first domain to the fourth domain.

8. The image display apparatus of claim 1, wherein each of the pixel electrodes comprises a first sub-pixel electrode and a second sub-pixel electrode, and the first sub-pixel electrode is applied with a voltage different from a voltage applied to the second sub-pixel electrode.

9. The image display apparatus of claim 8, wherein the opening portion is disposed in at least one of the first sub-pixel electrode and the second sub-pixel electrode.

10. The image display apparatus of claim 1, wherein the array substrate further comprises a plurality of data lines and a plurality of gate lines, and each of the pixel electrodes is disposed between two adjacent data lines among the plurality of data lines.

11. The image display apparatus of claim 10, wherein each of the pixel electrodes further comprises a first extension portion and a second extension portion overlapping the two adjacent data lines at a first overlap area and a second overlap area, respectively.

12. The image display apparatus of claim 11, wherein the opposite substrate further comprises a black matrix, and the black matrix covers at least one of the first overlap area and the second overlap area.

13. The image display apparatus of claim 1, further comprising:
a first alignment layer disposed on the pixel electrodes;
a second alignment layer disposed on a common electrode, the common electrode facing the pixel electrodes.

14. The image display apparatus of claim 13, wherein at least one of the first alignment layer and the second alignment layer defines the plurality of domains in each of the pixel electrodes to pre-tilt the plurality of vertical alignment liquid crystal molecules.

15. The image display apparatus of claim 13, wherein at least one of the first alignment layer and the second alignment layer comprises a polymer material in which at least one of a decomposition reaction, a dimerization reaction, and an isomerization reaction occurs in response to light.

16. The image display apparatus of claim 13, wherein at least one of the first alignment layer and the second alignment layer comprises a reactive mesogen.

17. The image display apparatus of claim 13, wherein the first alignment layer comprises a first area in which the first alignment layer is aligned in a first direction and a second area in which the first alignment layer is aligned in a second direction different from the first direction, and the second alignment layer comprises a third area in which the second alignment layer is aligned in a third direction different from the first and second directions and a fourth area in which the second alignment layer is aligned in a fourth direction different from the first, second, and third directions.

18. The image display apparatus of claim 17, wherein the domains comprise a first domain defined by an area in which the first area and the third area overlap each other, a second domain defined by an area in which the first area and the fourth area overlap each other, a third domain defined by an area in which the second area and the third area overlap each other, and a fourth domain defined by an area in which the second area and the fourth area overlap each other, liquid crystal molecules in the first domain are aligned in a fifth direction defined by a vector sum of the first and third directions, liquid crystal molecules in the second domain are aligned in a sixth direction defined by a vector sum of the first and fourth directions, liquid crystal molecules in the third domain are aligned in a seventh direction defined by a vector sum of the second and third directions, and liquid crystal molecules in the fourth domain are aligned in an eighth direction defined by a vector sum of the second and fourth directions.
